(19) United States
(12) Patent Application Publication
(10) Pub. No.: US 2025/0159508 A1
(43) Pub. Date: May 15, 2025

(54) OPPORTUNISTIC WIRELESS FRONTHAUL SYSTEM AND METHOD FOR UAV-ASSISTED COMMUNICATION NETWORK

(71) Applicant: INDIAN INSTITUTE OF TECHNOLOGY KHARAGPUR, Kharagpur (IN)

(72) Inventors: Byomakesh MAHAPATRA, Kharagpur (IN); Kirtan Gopal PANDA, Kharagpur (IN); Debarati SEN, Kharagpur (IN)

(73) Assignee: INDIAN INSTITUTE OF TECHNOLOGY KHARAGPUR, Kharagpur (IN)

(21) Appl. No.: 18/661,383

(22) Filed: May 10, 2024

(30) Foreign Application Priority Data
Nov. 13, 2023 (IN) 202331077296

(51) Int. Cl. H04W 24/04; H04B 10/112; H04W 4/021; H04W 4/90; H04W 84/06

(52) U.S. Cl. CPC H04W 24/04; H04B 10/1129; H04W 4/021; H04W 4/90; H04W 84/06

(57) ABSTRACT

A communication system and method for on-demand establishment of communication infrastructure over the target area comprising multiple Unmanned Aerial Vehicle (UAVs) mounted Flying Remote Radio Heads (F-RRH) (106) to provide communication services over the target area, one or more Static Remote Radio Heads (S-RRH) (102), one or more Base Band unit (BBU) antennas (103), optical fronthaul link (104) for connecting the S-RRH (102) and the BBU antennas (103) to a BBU-pool (101) and transceiver module on the F-RRH (106) for connecting with BBU antennas (103) through a dedicated optical fronthaul link (104) and/or connecting with transceiver module on the S-RRH (102) through an extended wireless fronthaul link (108), whereby each of the F-RRH transceiver modules is enabled for an opportunistic fronthauling which associates the F-RRH to its nearest working S-RRH for faster establishment of the fronthaul link though spectrum prediction and sensing.

### FIELD OF THE INVENTION

The present invention relates to establishment of an emergency communication infrastructure over a target area. More specifically the present invention is directed to a communication system and method for on-demand establishment of emergency communication infrastructure over the target area involving multiple Unmanned Aerial Vehicles (UAVs) mounted Flying Remote Radio Heads (F-RRH). The F-RRHs are advantageously configured to dynamically search the suitable unused spectrum from nearest Static-RRH (S-RRH) through opportunistic wireless fronthaul connection for establishment of the on-demand communication infrastructure at different target areas such as disaster zone, hotspot area or other unreachable areas etc., where the usual serving S-RRH are either damaged, destroyed, or overloaded.

### BACKGROUND OF THE INVENTION

The Unmanned Aerial Vehicle (UAV) based flying communication base station is now a key technology used to rapidly deploy micro communication base stations at on-demand target areas like disasters, hotspots, or remote geographical locations. The UAV's autonomy, mobility, and flexibility offer a cost-effective and fast deployable network in the target area with less physical effort. Integrating UAVs to the most promising 5G and beyond architecture, i.e., cloud radio access network (C-RAN), may offer a more flexible and cost-effective network.

The UAV-assisted C-RAN (UC-RAN) is a flexible RAN architecture comprising some static and UAV-based Remote Radio Heads (RRHs), alternatively known as Flying RRH (F-RRH). The selected F-RRH is connected to the Base Band Unit (BBU) antenna through a wireless fronthaul link. These wireless fronthaul links are operated over different frequency bands decided by the cellular operators.

In Opportunistic Fronthauling (OF) technique, the F-RRH of a UC-RAN network can search the available or free spectrum bands in the nearest neighborhood for connection establishment in a target area. As the F-RRH is an aerial vehicle and its position is randomly changing over a Target Deployment Area (TDA). This random movement makes it difficult for continuous use of a specific spectrum band or sub-band for wireless fronthaul link establishment between BBU antenna (or S-RRH) and the F-RRH. Further, as the F-RRH (or UAV) is a power constrained device, an increase in the spectrum searching time in the OF technique increases the battery power consumption as a result the F-RRH hovering or serving time will decrease which directly impact on the target mission completion over the TDA region.

A closer view on the reported works on the OF techniques would reveal that in Shehzad, M. K., Ahmad, A., Hassan, S. A. and Jung, H., “Backhaul-aware intelligent positioning of UAVs and association of terrestrial base stations for fronthaul connectivity”. IEEE Transactions on Network Science and Engineering, 8 (4), pp. 2742-2755., the fronthaul connectivity is not planed based on spectrum prediction and sensing and the deployment model doesn't include the fronthaul constrain like required bandwidth, communication range, and interference level etc.

In Luo, S., Xiao, Y., Lin, R., Xie, X., Bi, G., Zhao, Y. and Huang, J., “Opportunistic spectrum access for UAV communications towards ultra-dense networks”. IEEE Access, 7, pp 175021-175032. UAV worked as flying UEs and connected to the ground base station through an access network and spectrum prediction method is not used during spectrum occupancy identification.

In U.S. Pat. No. 10,638,501, an opportunistic uplink transmission method in between user entity and base station is proposed. The mentioned method is developed for a fixed base station without considering the split architecture C-RAN. Fronthaul connection establishment and its control and functions are not included.

In U.S. Pat. No. 9,654,168, the wireless fronthaul link works at a dedicated frequency band between a distributed and control unit of the C-RAN architecture. The mentioned wireless fronthaul is designed for short-distance communication between the control and distributed unit

It is thus there has been a need for developing a system and method for deploying the F-RRH at the target area which would intelligently takes F-RRH relocation decision based on the available fronthaul link and user coverage probability, ensuring that fronthaul link is best for the deployed F-RRH to perform spectrum sensing and to identify a suitable frequency sub-band at its location with a significant reduction in the spectrum searching time and corresponding power consumption of the system.

### OBJECT OF THE INVENTION

It is thus the basic object of the present invention is to develop a communication system and method for on-demand establishment of emergency communication infrastructure over the target area involving multiple Unmanned Aerial Vehicles (UAVs) mounted Flying Remote Radio Heads (F-RRH).

Another object of the present invention is to develop a system and method for enabling the F-RRHs to dynamically search and communicate suitable unused spectrum from nearest Static-RRH (S-RRH) through opportunistic wireless fronthaul connection for establishment of the on-demand communication infrastructure at different target areas such as disaster zone, hotspot area or other unreachable areas etc., where the usual serving S-RRH are either damaged, destroyed or overloaded.

Yet another object of the present invention is to develop a system and method for deploying the F-RRH at the target area including intelligently taking the F-RRH relocation decision based on the available fronthaul link and user coverage probability, ensuring that identified arc length is best for deployment of the F-RRH to perform spectrum sensing and to identify a suitable frequency sub-band at these location with a significant reduction in the spectrum searching time and corresponding power consumption of the system.

A still further object of the present invention is to develop a system and method for deploying the F-RRH at the target area involving Knowledge based Energy Detection (KED) method at transceiver unit of the F-RRH to reduce the spectrum searching time and corresponding power consumption the deployed F-RRH.

A still further object of the present invention is to develop a system and method for determining best suitable spectrum sub-band and the corresponding 3-D location for the F-RRH through a Learning-Based Spectrum Prediction (LSP) method.

### SUMMARY OF THE INVENTION

Thus, according to the basic aspect of the present invention there is provided a communication system for on-demand establishment of communication infrastructure over the target area comprising
multiple Unmanned Aerial Vehicle (UAVs) mounted Flying Remote Radio Heads (F-RRH) (106) to provide communication services over the target area;
one or more Static Remote Radio Heads (S-RRH) (102);
one or more Base Band Unit (BBU) antennas (103);
optical fronthaul link (104) for connecting the S-RRH (102) and the BBU antennas (103) to a BBU-pool (101);
transceiver module on the F-RRH (106) for connecting with BBU antennas (103) through a dedicated optical fronthaul link (104) and/or connecting with transceiver module on the S-RRH (102) through an extended wireless fronthaul link (108), whereby each of the F-RRH transceiver modules is enabled for an opportunistic fronthauling which associates the F-RRH to its nearest working S-RRH for faster establishment of the fronthaul link though spectrum prediction and sensing.

In the present system, the BBU-pool (101) includes
a reconnaissance UAV; and
a computer server-based UAV Traffic Management (UTM) unit having operative controlling connection to F-RRH and the reconnaissance UAV.

In the present system, the UTM unit deploys and controls the reconnaissance UAV to collect location and spectrum availability information of working as well as destroyed or damaged S-RRH in the target area including uncovered UE locations corresponding to the destroyed or damaged S-RRH for defining a Target Deployment Area (TDA) and possible F-RRH deployment at 3D positions inside said TDA through a Learning-based Spectrum Prediction (LSP) method based on the spectrum availability information collected from the reconnaissance UAV.

In the present system, the UTM deploys and controls the F-RRH to reach to the predicted 3D positions and a spectrum detector in the transceiver module of F-RRH performs spectrum sensing on reaching the predicted 3D positions to detect actual condition of the available spectrum, whereby if the sensed spectrum sub-band condition is suitable for fronthaul application, then the F-RRH informs the UTM unit to use the spectrum for a specific period and in case the sensed spectrums are unsuitable, the F-RRH enters a relocation phase, wherein the UTM unit reused the LSP model to identify new 3D position within the TDA and after determining the new 3D position, the F-RRH relocated to the new position by the UTM unit to perform the spectrum sensing task to identify the current utilization of the predicted spectrum.

According to a further aspect of the present invention there is provided a method for on-demand establishment of communication infrastructure over the target area involving the above system comprising.
determining initial deployment for the F-RRH (106) at the UTM unit located at the BBU-pool (101) involving
   sending the reconnaissance UAV in advance to the target area for collecting location and spectrum availability information of working as well as destroyed or damaged S-RRH in the target area including uncovered UE locations corresponding to the destroyed or damaged S-RRH;
   defining the Target Deployment Area (TDA) based on the colleting location and spectrum availability information including TDA boundary, arc length and discrete positions on arc (arc points);
   determining possible F-RRH deployment 3D positions inside said TDA through the Learning-based Spectrum Prediction (LSP) method based on the spectrum availability information collected from the reconnaissance UAV;
initiating the F-RRH UAVs by the UTM unit to reach to the predicted 3D positions based on the outcomes of the LSP;
involving the spectrum detector in the transceiver module of the F-RRH to performs spectrum sensing on reaching the predicted 3D positions to detect actual condition of the available spectrum, whereby if the sensed spectrum sub-band condition is suitable for fronthaul application, then the F-RRH informs the UTM unit to use the spectrum for a specific period and in case the sensed spectrums are unsuitable, the F-RRH enters a relocation phase, wherein the UTM unit reused the LSP model to identify new 3D position within the TDA and after determining the new 3D position, the F-RRH relocated to the new position by the UTM unit to perform the spectrum sensing task to identify the current utilization of the predicted spectrum.

In the above method, the TDA includes a disaster area with destroyed or damaged S-RRHs with overlapping cellular communication regions by the existing working S-RRH adjacent to the TDA, whereby defining the TDA includes identifying the overlapped cellular boundaries or arc length (302) where the F-RRH simultaneously gets a significant number of UE coverage and signal strength for the fronthaul applications by calculating length of each arc with the TDA region of the UTM unit (307);
wherein the calculating the arc length by the BBU unit involves considering a circular target area which overlaps with several adjacent circular cellular cells, where each adjacent cell has a base station at its center point with a coverage radius of ‘R’ and area of overlap between TDA and any of the adjacent cells is called the overlap area and the boundary of this overlap area is identified as the arc length.

In the above method, the determination of the possible F-RRH deployment 3D positions inside the TDA includes
identifying discrete possible locations over the arc length, to reduce F-RRH deployment time and calculating the number of 3D arc positions and inter-distance between them based on the arc length and the altitude of the F-RRH (308), wherein calculating the number of 3D arc positions involves determination of two endpoints of the arc length and other points over this arc by taking into consideration of coverage diameter of the F-RRH at a particular height, where each point over this arc is separated from each other by a length of coverage radius of the F-RRH and after determination of the all 2D points over the arc, 3D positions over this arc are obtained by varying the height (Z coordinate) over the identified 2D arc position, whereby minimum and maximum height of 3D positions are determined by considering the F-RRH transmission range and nature of the terrain;
initiating LSP model based on information regarding occupancy detail and attenuation profile for each available sub-band at the adjacent cells of the working S-RRH over the 3D arc positions as collected by the reconnaissance UAV to identify an optimum 3D position across each overlap arc length of the adjacent cells (310), whereby after obtaining the optimal 3D position, the UTM unit selects the required number of the F-RRH UAVs and instructs them to station at the determined 3-D positions laying over the overlap arc length (311).

The above method includes post F-RRH deployment process involving the spectrum detector to know the post F-RRH deployment occupancy of the predicted spectrum sub-band comprising scanning the predicted sub-bands and their signal strength at the F-RRH deployed location (401) based on a transmitter detection mechanism using a knowledge-based energy detection (KED) method which works based on received signal strength measured in terms of Signal to Noise Ratio (SNR) at the transceiver module of the F-RRH (402);
wherein, if the received SNR is larger than a threshold SNR then the F-RRH transmits control information to the UTM unit regarding temporary occupancy of the selected spectrum for the establishment of the fronthaul link (403) and ff the UTM unit permits the F-RRH to use the identified sub-band, then it occupies the selected band for a time period (To) (404) which is decided based on average temporal traffic variation over the selected sub-band;
wherein the KED method (500) involves the spectrum detector (501) to identify the free spectrum sub-band based on the received SNR (402) and a noise estimator (502) to estimates presence of noise in the received signal and helps in hypothesis testing in order to identify the condition of the predicted spectrum sub-band, whereby the transceiver module of the F-RRH at a 3D arc position senses the targeted sub-band for a sensing period ‘Tₛ’ and estimates the spectrum sub-band conditions by the use of hypothesis testing as

$$\{ \begin{matrix}{H}_{0} : y ( t ) = w ( t ) , \\ {H}_{1} : y ( t ) = hx ( t ) + w ( t )\end{matrix} \qquad \begin{matrix}( 1 ) \\ ( 2 )\end{matrix}$$

where, y(t) is the output signal analysis over sensing time period ‘Tₛ’ and w(t) is the noise over a fading channel and x(t) is the input sample signal.

In the above method, the KED method involves a threshold estimator (503) to considers prior knowledge and estimates the threshold value for sensed spectrum sub-band, whereby the KED method utilizes the information obtained from the LSP method (305) as the prior knowledge about the spectrum sub-band and geographical location which helps to reduce the spectrum selection and searching time during the post-deployment phase.

The above method also includes relocation of the deployed F-RRH to a new 3-D position over the arc length depending on availability of currently used sub-band by the corresponding F-RRH, wherein the relocation to the new 3-D arc position is based on the knowledge of sub-band SNR values obtained in (310) and through the LSP method by interacting with environment and learning through actions' consequences, whereby the LSP method uses states and actions to predict the next location, here, the states include the probable 3-D positions and actions are the directions of F-RRH and in each state, the F-RRH observes and accumulates the SNR conditions, gathers location information, and takes corresponding actions for its next movement.

### BRIEF DESCRIPTION OF THE DRAWINGS

FIG. 1. F-RRH deployment over target areas.

FIG. 2. Phases involve in F-RRH deployment and opportunistic link establishment.

FIG. 3. F-RRH initial deployment phase. (a) Determination of TDA, overlap arc length and arc points for F-RRH initial deployment, (b) Steps for F-RRH initial deployment over TDA.

FIG. 4. Steps involve in sensing and detection phase.

FIG. 5. Steps involve in knowledge-based energy detection technique.

FIG. 6. Steps involve in F-RRH Relocation phase.

FIG. 7 UEs association with S-RRHs.

FIG. 8 Identification of TDA region and initial F-RRH placement over the arc.

FIG. 9. The Received SNR and UE covered (%) for F-RRH-2 over the distance from S-RRH-2.

FIG. 10. Fronthaul detection probability vs the received SNR concerning S-RRH-2 with different K factor value over a Rician fading channel.

FIG. 11. Optimum 3-D position of F-RRH-2 obtained by LSP method.

FIG. 12 Normalized received SNR and normalized number of UEs covered by F-RRH for random distance and arc distance from S-RRH.

FIG. 13 Received SNR for random 3-D positions and LSP based 3-D position for F-RRH-2.

### DETAILED DESCRIPTION OF THE INVENTION

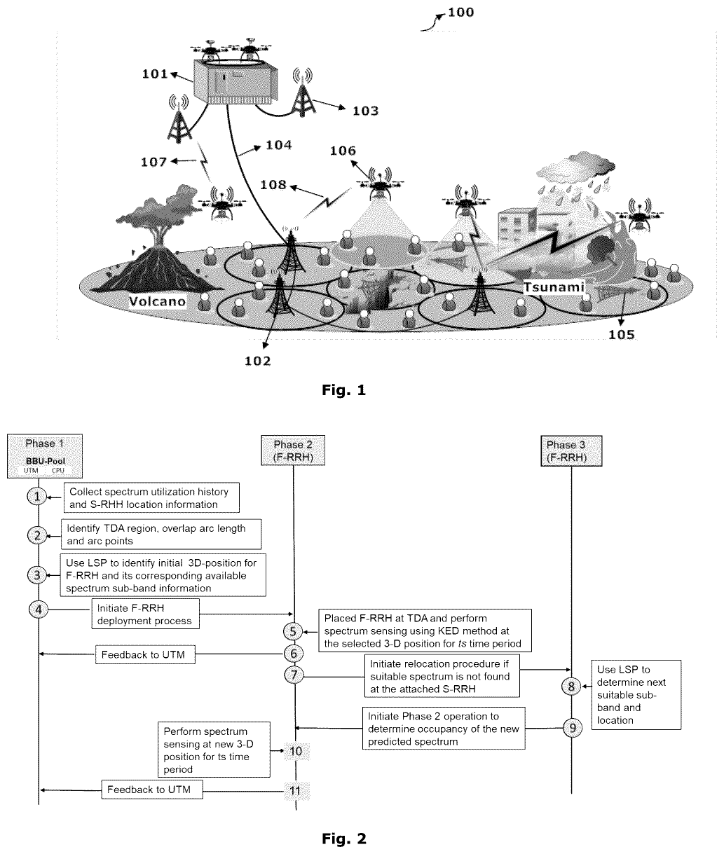

A transceiver module mounted on UAV may be a promising solution to provide on-demand communication services over a disaster, hotspot, or other demanding areas like hilly and remote regions. The module can be either a complete potable base station (i.e., eNodeB) or a distributed unit as an RRH in C-RAN architecture. This work considers a distributed UC-RAN architecture, where the transceiver module is located at the S-RRH (102) and mounted over an F-RRH (106). The S-RRH and BBU antennas (103) are connected to the BBU-pool (101) through a dedicated optical fronthaul link (104), whereas the F-RRH are connected over a wireless fronthaul link (107) or through an extended wireless fronthaul link (108). FIG. 1 shows the overall mechanisms to provide communication over a target area. In this model, some of the S-RRHs (105) are destroyed or damaged due to either eruption of the volcano, tsunami or earthquake, etc. The damage to existing communication infrastructure restricts the search and rescue (SAR) operations in these disaster-affected areas. In order to provide emergency communication services over these target areas, this work proposed an opportunistic fronthauling method to associate a F-RRH to its nearest S-RRH. The opportunistic sub-band selection based on two mechanisms i.e., spectrum prediction and spectrum sensing. Under spectrum prediction, the system predicts the availability of spectrum for different locations. Whereas, sensing helps to identify the actual condition or utilization of the predicted spectrums. The implementation of the proposed work is carried out in three different phases, which are 1) F-RRH initial deployment phase, 2) F-RRH post-deployment phase, and 3) F-RRH relocation phase.

FIG. 2 depicts the steps involved under different phases and their interdependencies during the deployment and operation of UC-RAN. To get optimum connectivity and coverage over a target area, the initial deployment planning for F-RRH is carried out at the UAV Traffic Management (UTM) unit located at the BBU-pool. For this planning, the UTM needs location and spectrum availability information at the existing as well as the destroyed or damaged S-RRH. This required information is collected by sending a reconnaissance UAV in advance to the target area (Step 1). After getting the destroyed or damaged S-RRH location and their uncovered UE locations, it is required to define a Target Deployment Area (TDA) and possible F-RRH deployment positions inside TDA. Thus, the TDA boundary, arc length and discrete positions on arc (arc points) are calculated in Step 2. In order to find out an optimal 3-D position for F-RRH, the system used a Learning-based Spectrum Prediction (LSP) method in Step 3 based on the spectrum availability information collected in advance. Here, LSP method is similar to Temporal difference learning method used for future prediction. Based on the outcomes of the LSP, the UTM initiates the deployment process of F-RRHs at the predicted 3D positions inside TDA (Step 4).

To calculate the overlap arc length, a circular target area is considered which overlaps with several adjacent circular cellular cells. Each adjacent cell has a base station at its center point with a coverage radius of ‘R’. Now the area of overlap between TDA and any of the adjacent cells is called the overlap area and the boundary of this overlap area is identified as the arc length. The overlapping conditions between adjacent cells are determined by using the circle-circle intersection technique, which initially found the intersection point and by taking the intersection point we get the final arc. The arc length calculation is carried out at the general processor of the base band unit (BBU).

In the process of arc point determination, initially, two endpoints of the arc length are determined to know the length of the arc. The other points over this arc are determined by taking into consideration of the coverage diameter of the F-RRH at a particular height. Each point over this arc is separated from each other by a length of coverage radius of F-RRH. After determination of the all 2D points (XY coordinate) over the arc, 3D positions over this arc are obtained by varying the height in the (Z coordinate) over the identified 2D arc position found in the above step. Here the minimum and maximum height of 3D positions are determined by considering the F-RRH transmission range and nature of the terrain.

After reaching the predicted 3D position, the F-RRH performs spectrum sensing to know the actual condition of the predicted sub-band using a Knowledge-Based Detection (KED) method, as shown in Step 5. If the sensed spectrum sub-band condition is suitable for fronthaul application, then the F-RRH informs the UTM and takes permission to use the spectrum for a specific period (Step 6). In case the sensed spectrums are unsuitable, the F-RRH enters the relocation phase (Step 7). In Step 8, the LSP model used in Phase 1 is again used at F-RRH to identify the new 3D position within the overlap arc length. After determining the new 3D position, the F-RRH relocated to the new position and performed the spectrum sensing task to identify the current utilization of the predicted spectrum, shown in Step 10. The information shared by the F-RRH to the UTM at Step 6 or Step 11 helps the operators for smooth control of F-RRH and improve its placement decision for future placement. The detailed operations of the three different phases are described below.

The Learning based Spectrum Prediction (LSP) method is executed on the processor (hardware) that resides at the BBU-pool and F-RRH. In this work, the developed LSP method is a prediction technique used to get an optimum 3D position across each overlap arc length of the adjacent cells. The LSP model uses a finite state Markov Decision Process (MDP) model over a database collected by the reconnaissance UAV for the next prediction. In the MDP the agent interacts with the environment and based on the learning outcome the agent decides its next state by taking certain action. In this work, the F-RRH is considered as an agent and the collected database is considered as the environment. The LSP method initially runs for several iterations at the C-BBU processor to determine the initial 3D position over the arc length. The learning outcome suggested 3D points where the normalized difference between coverage probability and received SNR is minimum. The developed model is further used by the F-RRH transceiver unit to make relocation decisions.

The reconnaissance UAV used a spectrum detector at the transceiver unit that use the transmitter detection principle for spectrum detection, spectrum band availability, and SNR information. This is done by scanning and analyzing the received signal sample collected over a time period.

### Phase 1: F-RRH Initial Deployment Phase

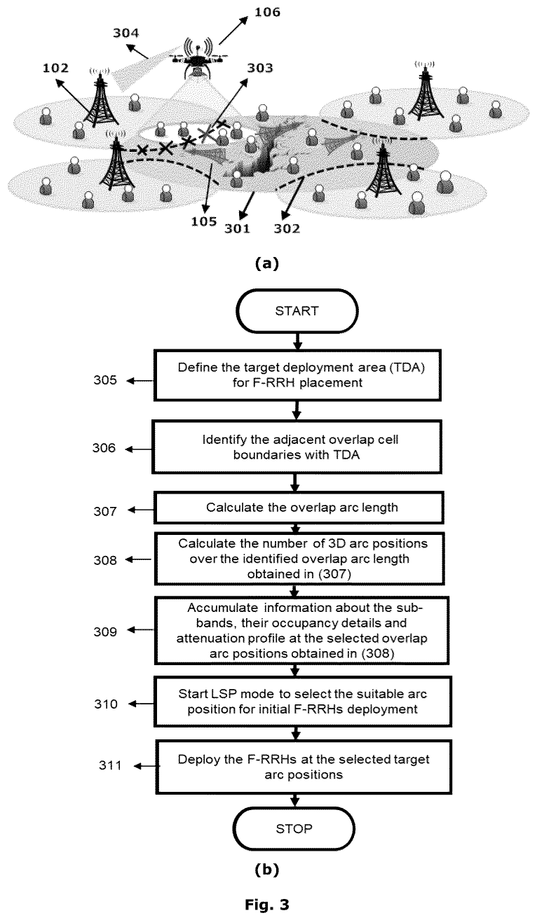

The operator initially defines the TDA region (301), which is the first step (305) of F-RRH initial deployment phase shown in the FIG. 3. The TDA region can be a disaster area with destroyed or damaged S-RRHs. There will be overlapping cellular regions by the existing S-RRH adjacent to TDA. For finding the 3-D position of F-RRH, the overlapped cellular boundaries, also known as arc length (302), may be considered the best region, where F-RRH simultaneously gets a significant number of UE coverage and signal strength for fronthaul applications. Hence, it is required to identify the overlapping cellular boundary with the TDA (306). The length of each arc (i.e., overlapping cell boundaries) with the TDA region is calculated by the UTM unit of BBU-pool as mentioned in (307). It is required to identify discrete possible locations over the continuous search space, i.e., arc length, to reduce F-RRH deployment time. So, the number of 3D arc positions and inter-distance between them is calculated based on the arc length and the altitude of the F-RRH (308).

The information regarding occupancy detail and attenuation profile for each available sub-band at the adjacent cells (S-RRH) over the 3D arc positions are collected by sending a reconnaissance UAV prior to the actual deployment of F-RRH (309). Based on the collected information, the BBU-pool initiates the learning-based spectrum prediction (LSP) training model to identify an optimum 3D position across each overlap arc length of the adjacent cells (310). After obtaining the optimal 3D position, the UTM selects the required number of F-RRH from the workshop and instructs them to station at the determined 3-D positions laying over the overlap arc length (311).

### Phase 2: F-RRH Post-Deployment:

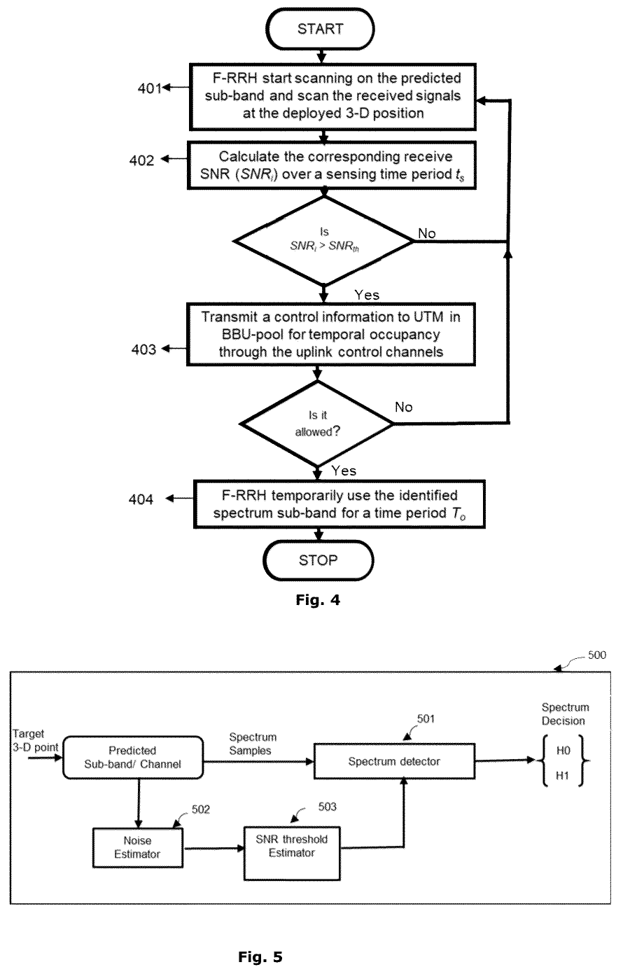

The identified spectrum sub-band (in 309) has a temporal-spatial behavior due to the random arrival of registered UEs over this sub-band. So, to know the present occupancy of the predicted sub-band, a spectrum sensing process is carried out, which is shown in FIG. 4. The spectrum sensing process starts with scanning the predicted sub-bands and their signal strength at the F-RRH deployed location (401). The spectrum sensing at the deployed F-RRH (106) is based on a transmitter detection mechanism using a knowledge-based energy detection (KED) method described in FIG. 5. The KED method works based on the received signal strength measured in terms of Signal to Noise Ratio (SNR) at the transceiver module of the F-RRH (402). During this evaluation, if it is found that the received SNR is larger than the threshold SNR then F-RRH transmits control information to the UTM in the BBU-pool regarding the temporary occupancy of the selected spectrum for the establishment of the fronthaul link (403). The SNR threshold is determined as per G. Giovanni, A. Garcia-Rodriguez, L. G. Giordano, D. López-Pérez, and E. Björnson. “Understanding UAV cellular communications: From existing networks to massive MIMO.” IEEE Access, vol. 6, pp. 67853-67865, 2018. If the UTM permits the F-RRH to use the identified sub-band, then it occupies the selected band for a time period (Tₒ) (404). Here, the occupied time period ‘To’ is decided based on the average temporal traffic variation over the selected sub-band.

The KED method (500), shown in FIG. 5, uses a spectrum detector (501) within the transceiver module of the F-RRH to identify the free spectrum sub-band based on the received SNR obtained in (402). The noise estimator (502) estimates the presence of noise in the received signal and helps in hypothesis testing in order to identify the condition of the predicted spectrum sub-band. The transceiver module of the F-RRH at a 3D arc position senses the targeted sub-band for a sensing period ‘Tₛ’ and estimates the spectrum sub-band conditions by the use of hypothesis testing as given below:

$$\{ \begin{matrix}{H}_{0} : y ( t ) = w ( t ) , \\ {H}_{1} : y ( t ) = hx ( t ) + w ( t )\end{matrix} \qquad \begin{matrix}( 1 ) \\ ( 2 )\end{matrix}$$

where, y(t) is the output signal analysis over sensing time period ‘Tₛ’ and w(t) is the noise over a fading channel and x(t) is the input sample signal. The threshold estimator (503) considers the prior knowledge and estimates the threshold value for sensed spectrum sub-band. The KED method utilizes the information obtained from the LSP method described in (305) as a prior knowledge about the spectrum sub-band and geographical location. It helps to reduce the spectrum selection and searching time during the post-deployment phase.

### Phase3: F-RRH Relocation:

The service time of F-RRH over the deployed location inside TDA (301) depends on the spectrum availability at the adjacent S-RRH (102). Traffic at the adjacent S-RRHs varies with respect to time which directly impacts the occupancy of the currently used sub-band by the corresponding F-RRH.

To overcome this, the F-RRH needs to relocate to a new 3-D position over the arc length to get a new spectrum sub-band in order to establish a fronthaul link. Relocation to the new 3-D arc position is based on the knowledge of sub-band SNR values obtained in Phase 1 (310) and through the LSP method by interacting with the environment and learning through actions' consequences. The LSP method running at the F-RRH uses states and actions to predict the next location. Here, the states include the probable 3-D positions, and actions are the directions of F-RRH. In each state, the F-RRH observes and accumulates the SNR conditions, gathers location information, and takes corresponding actions for its next movement.

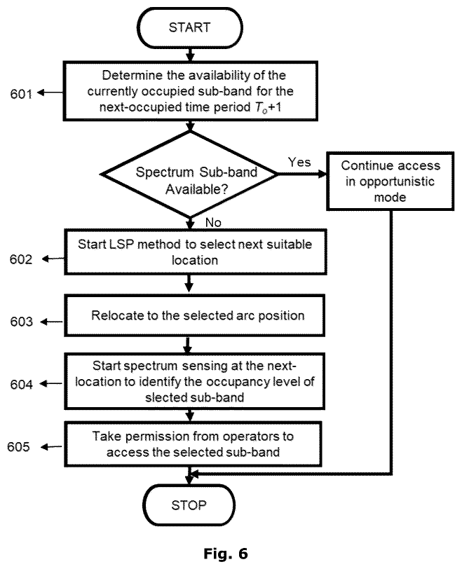

FIG. 6 depicts the steps involved in F-RRH relocation over the arc length. It is required to evaluate the occupied sub-bands condition after a time interval ‘To’ and determines its availability for the next time slot ‘Tₒ+1’ (601). Suppose the system does not find its availability for the next time slots (Tₒ+1). In that case, F-RRH executes the LSP training method (602) to predict the next 3D position and identify the corresponding available sub-band from the available spectrum bands (603). Based on the predicted information, the F-RRH moves to the next location. After reaching the next location, the F-RRH performs phase 2 operation to determine the condition and sub-band occupancy details for fronthaul link establishment (604). By taking permission from the cellular operator, the F-RRH uses the identified spectrum for a specific time period (605).

This invention has many significant advantages which are:
Supports multi-RAT and facilitates the use of wider spectrum band.
Supports on-demand deployment and provides a rapid connectivity at the target area.
Supports dynamic split network architecture for 5G and beyond C-RAN compliance network architecture.
Reduces connectivity loss due to spectrum scarcity.
Enables distributed learning-based method at the F-RRH for spectrum prediction for the current and next location.
Auto relocation of swarm of F-RRH network based on continuous spectrum prediction and sensing to minimize outage and maximize connectivity with guaranteed QoS.
Enhances deployment flexibility in C-RAN due to use of F-RRH.
Flexibility of using wide range of frequencies via spectrum prediction and sensing for the deployment of the terrestrial network at the unreachable areas.

### Testing:

This section evaluates the performance of the proposed work by using simulation. For the initial deployment of the S-RRH, we have used the Thomas Cluster Point Process (TCPP), where the parent and daughter processes are used for S-RRH and user distribution. The TCPP is selected as it gives a real-time S-RRH and its user distribution. The features of TCPP help to model UE association in an on-demand and unpredictable traffic environment like a disaster or hotspot area. The UEs are distributed over 10 km², and the S-RRHs are deployed over this area with a cell radius of 2000 meters. Tₒ avoid coverage holes, the adjacent cells are overlapped. The list of simulation parameters used for the analysis of the proposed method is listed in Table. 3.

TABLE 3
List of simulation parameters and values

| Parameter | Value (s) | |
|---|---|---|
| Simulation Area (Aₜ) | 10 | km² |
| S-RRH coverage radius | 2 | km |
| F-RRH maximum coverage radius for ground | 250 | meter |
| UEs | | |
| Maximum noise power received at F-RRH | − 120 | dBm |
| receiver unit (Pₙ) | | |
| Maximum transmit power by the S-RRH (Pt) | 31 | dBm |

| | |
|---|---|
| Minimum and maximum receive SNR range | −20 dB to +20 dB |
| Operating frequency range (Rₜ) | 729 MHz to 5 GHz |

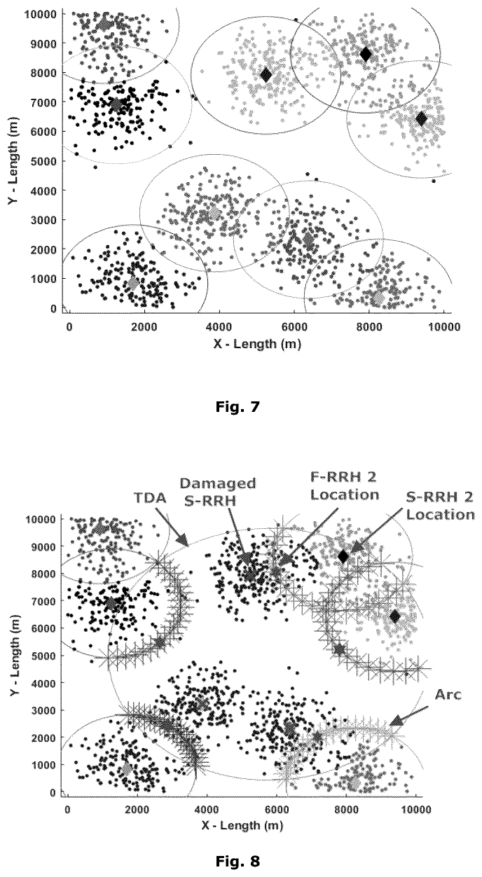

FIG. 7 shows the initial UE assignment to the S-RRHs. The UEs association with S-RRH is based on the Euclidean distance. If a UE is inside the coverage radius of an S-RRH and the Euclidean distance is minimum with respect to the corresponding S-RRH, then UE is assigned. While serving the UEs, some S-RRHs may be destroyed or damaged due to man-made or natural disasters. After the failure of an S-RRH, the UEs assigned to it remain unserved/uncovered. In this scenario, F-RRH can play an important role in providing immediate service. For the deployment of F-RRHs to serve uncovered UEs, the TDA region must first identify.

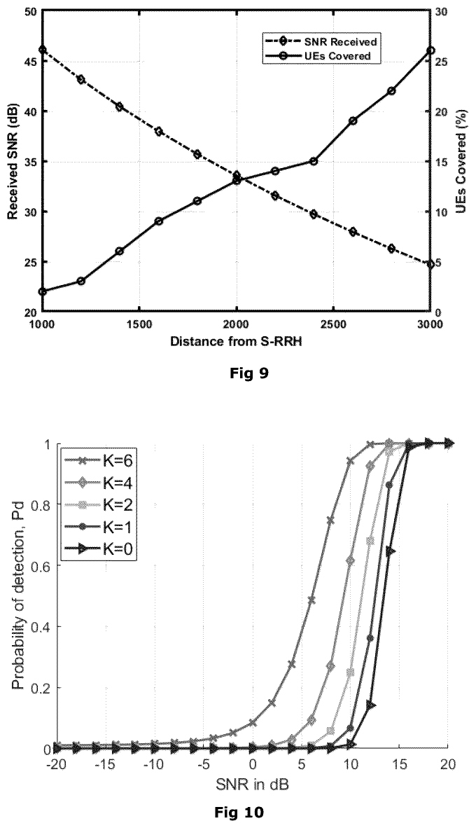

FIG. 8 shows the TDA region as a big circular area with a minimum radius that covers all uncovered UEs of the failure S-RRHs. In order to connect the F-RRH with the BBU, we consider existing S-RRHs near the TDA. F-RRH needs to communicate to existing S-RRH over the wireless fronthaul. In order to get a better SNR for wireless fronthaul and a significant number of UE associations simultaneously, the overlapped cellular boundaries, also known as arc length, is the best region for F-RRH placement (refer FIG. 9). The F-RRH considers a 3-D position (red colour star) over the arc length that is obtained from the LSP method (FIG. 8).

FIG. 9 justifies that for getting a better wireless fronthaul link and a significant number of UE associations simultaneously, the arc length is suitable for F-RRH placement. Here, F-RRH-2 is considered for finding the received SNR and number of covered UEs from TDA for different distances from S-RRH-2. If F-RRH-2 moves away from S-RRH-2, the number of unserved UEs associated with F-RRH-2 increases, whereas the SNR from S-RRH-2 decreases. The overall gain of both received SNR and the number of UEs association will be maximum over the arc length that exists over the S-RRH-2 coverage radius.

The arc length is determined from the cross-section of the circumference of the TDA region and the existing S-RRH coverage area. Over the arc length, the possible F-RRH 3-D positions are identified with the variation in longitude, latitude and altitude. The LSP method finds the best 3-D position over the arc length that offers the best wireless link between S-RRH and F-RRH. The LSP method completes its work under two phases, exploration followed by exploitation. Under exploration, the F-RRH is initially placed at different 3-D positions over the corresponding arc length to measure the received SNR and then by exploiting the learning during exploration, a suitable 3-D position is identified for wireless fronthaul connection in the exploitation phase.

FIG. 10 shows the fronthaul detection probability of the F-RRH-2 over Rician fading channels at the selected arc position. Here, the more the line-of-sight (LOS) path between the F-RRH-2 and the adjacent S-RRH-2, more the chance of getting the better fronthaul link. In this analysis, when K=0, the channel becomes Rayleigh fading channel and no dominated LOS path exists between F-RRH-2 and the S-RRH-2, which reduces the chance of getting a dominated fronthaul link.

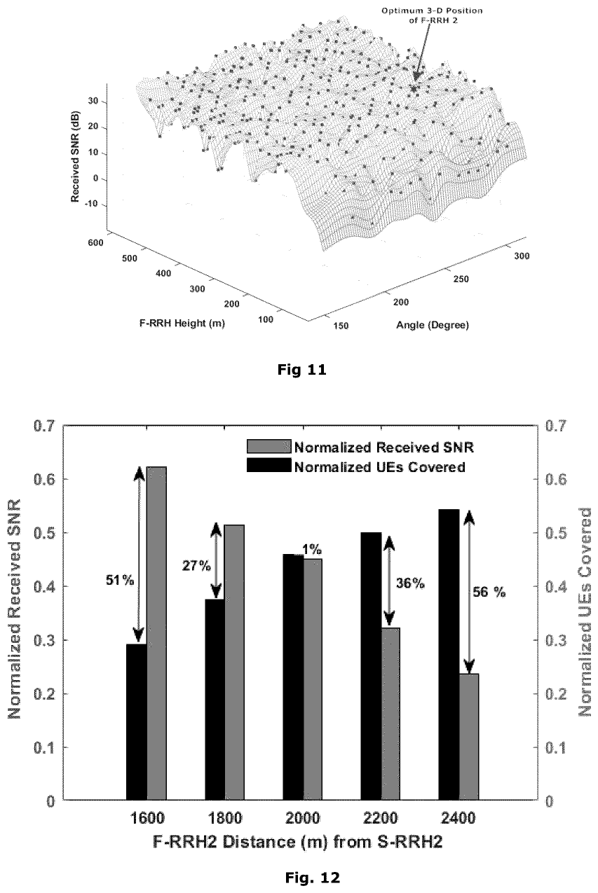

FIG. 11 shows the received SNR at different 3-D positions over the arc length for F-RRH-2 obtained by the LSP method. During the exploration of LSP method, F-RRH-2 selects random actions to learn the outcomes as received SNR for its different actions. The action can be forward, backward, up and down, which finally maps to a 3-D position. Based on the learning, i.e., LSP, the F-RRH-2 finally reached an optimal 3-D position under the exploitation phase. In FIG. 10, the blue dots represent all the possible sampling 3-D positions over the arc and the red hexagon represents the optimal 3-D position for F-RRH placement.

Comparative Study: In order to quantify the potentiality of the proposed method for opportunistic fronthaul application, a comparative study is carried out with the random deployment method. As the proposed strategy considers the 3-D deployment of F-RRH over the arc length using the LSP method, thus two types of comparative studies are made to justify: a) Selecting the arc length as the best possible F-RRH distance from S-RRH to get better received SNR and number of UEs covered, b) Use of LSP method for 3-D placement of F-RRH over the arc length. The F-RRH-2 is considered for the above comparison study.

a. Selecting the arc length: We consider the random distance from S-RRH-2 for the F-RRH 2 placement, including the arc distance from S-RRH-2 center location (FIG. 8). For those distances, we estimate the received SNR at the FRRH-2 over the wireless fronthaul link and the number of unserved UEs covered inside TDA by the F-RRH-2. The value of received SNR and number of UEs covered for different distances is given in Table. 4. FIG. 11 shows the normalized SNR and normalized UEs covered for the considered distances. Note, the SNR normalization and covered UEs normalization are done for a maximum and minimum value of (46.08, 24.65) and (5, 59) respectively (as per FIG. 8). For the F-RRH-2, it is required to select a 2-D distance from S-RRH-2 where both received SNR and the number of covered UEs will be maximum, so that F-RRH-2 will get a better fronthaul connectivity while serving more number of unserved UEs from TDA. It is observed that only at the arc distance the variation between normalized SNR and covered UEs is minimum. Thus, placing F-RRH over the arc length is beneficial as compared to deploying F-RRH at any random distance from S-RRH.

TABLE 4
Received SNR and UEs covered by F-RRH-2
for different distances from S-RRH-2

| F-RRH Placement | Distance | Received SNR | Number of UEs |
|---|---|---|---|
| Type | (m) | (dB) | Covered in TDA |
| Random Placement | 1600 | 37.95 | 20 |
| | 1800 | 35.67 | 25 |
| | 2200 | 31.52 | 32 |
| | 2400 | 29.68 | 34 |
| Arc Placement | 2000 | 33.55 | 29 |

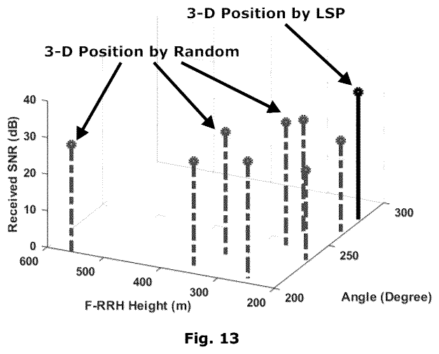

b. Use of LSP method: Over the arc length, several random 3-D positions are considered for F-RRH-2 placement by varying the polar coordinate ‘azimuthal angle’ and the F-RRH-2 altitude. Here, the distance of F-RRH-2 from S-RRH 2 is not varied for 3-D location selection as over the arc length; the distance remains the same. Using the LSP method, the best 3-D positions are obtained, where the received SNR from S-RRH 2 is maximum. FIG. 12 shows the received SNR for random 3-D positions, including the LSP method-based 3-D position. As over the arc length at the different 3-D positions, the attenuations are different either due to blockage by the skyscrapers and trees or lack of line of sight connection due to F-RRH antenna orientation. Thus, finding the best 3-D position by learning from the environment is essential, which is accomplished by the LSP method. It is observed the LSP-based 3-D position offers better received SNR as compared to other random 3-D positions. A numerical comparison between random and proposed LSP methods is given in Table 5. The attributes mentioned in columns two and three (i.e., angle and height) together give a 3-D location of F-RRH 2. The Table. 5 represents that the received SNR value at a 3D location obtained from the LSP method is significantly high compared to the SNR value obtained at the randomly deployed positions. The maximum SNR improved for LSP-based 3-D position as compared to random 3-D positions is 27.4%. The maximum SNR magnitude obtained from LSP makes it suitable for opportunistic wireless fronthaul applications in UAV-assisted cellular networks.

TABLE 5
Received SNR and UEs covered by F-RRH-2
for different distances from S-RRH-2

| 3-D Deployment | Angle | F-RRH | Received | Improved SNR |
|---|---|---|---|---|
| Type | (Deg) | Height (m) | SNR (dB) | due to LSP |
| Random 3-D | 200 | 557 | 29.18 | 13.8% |
| Position | 208 | 357 | 28.44 | 15.9% |
| | 205 | 257 | 32.02 | 6.4% |
| | 224 | 332 | 33.55 | 2.6% |
| | 232 | 207 | 24.67 | 27.4% |
| LSP based 3-D | 280 | 207 | 34.67 | 0% |
| Position | | | | |

1. A communication system for on-demand establishment of communication infrastructure over the target area comprising
multiple Unmanned Aerial Vehicle (UAVs) mounted Flying Remote Radio Heads (F-RRH) (106) to provide communication services over the target area;
one or more Static Remote Radio Heads (S-RRH) (102);
one or more Base Band unit (BBU) antennas (103);
optical fronthaul link (104) for connecting the S-RRH (102) and the BBU antennas (103) to a BBU-pool (101);
transceiver module on the F-RRH (106) for connecting with BBU antennas (103) through a dedicated optical fronthaul link (104) and/or connecting with transceiver module on the S-RRH (102) through an extended wireless fronthaul link (108), whereby each of the F-RRH transceiver modules is enabled for an opportunistic fronthauling which associates the F-RRH to its nearest working S-RRH for faster establishment of the fronthaul link though spectrum prediction and sensing.

2. The system as claimed in claim 1, wherein the BBU-pool (101) includes
a reconnaissance UAV; and
a computer server-based UAV Traffic Management (UTM) unit having operative controlling connection to F-RRH and the reconnaissance UAV.

3. The system as claimed in claim 2, wherein the UTM unit deploys and controls the reconnaissance UAV to collect location and spectrum availability information of working as well as destroyed or damaged S-RRH in the target area including uncovered UE locations corresponding to the destroyed or damaged S-RRH for defining a Target Deployment Area (TDA) and possible F-RRH deployment at 3D positions inside said TDA through a Learning-based Spectrum Prediction (LSP) method based on the spectrum availability information collected from the reconnaissance UAV.

4. The system as claimed in claim 3, wherein the UTM deploys and controls the F-RRH to reach to the predicted 3D positions and a spectrum detector in the transceiver module of F-RRH performs spectrum sensing on reaching the predicted 3D positions to detect actual condition of the available spectrum, whereby if the sensed spectrum sub-band condition is suitable for fronthaul application, then the F-RRH informs the UTM unit to use the spectrum for a specific period and in case the sensed spectrums are unsuitable, the F-RRH enters a relocation phase, wherein the UTM unit reused the LSP model to identify new 3D position within the TDA and after determining the new 3D position, the F-RRH relocated to the new position by the UTM unit to perform the spectrum sensing task to identify the current utilization of the predicted spectrum.

5. A method for on-demand establishment of communication infrastructure over the target area involving the system as claimed in claim 4 comprising
determining initial deployment for the F-RRH (106) at the UTM unit located at the BBU-pool (101) involving
sending the reconnaissance UAV in advance to the target area for collecting location and spectrum availability information of working as well as destroyed or damaged S-RRH in the target area including uncovered UE locations corresponding to the destroyed or damaged S-RRH;
defining the Target Deployment Area (TDA) based on the colleting location and spectrum availability information including TDA boundary, arc length and discrete positions on arc (arc points);
determining possible F-RRH deployment 3D positions inside said TDA through the Learning-based Spectrum Prediction (LSP) method based on the spectrum availability information collected from the reconnaissance UAV;
initiating the F-RRH UAVs by the UTM unit to reach to the predicted 3D positions based on the outcomes of the LSP;
involving the spectrum detector in the transceiver module of the F-RRH to performs spectrum sensing on reaching the predicted 3D positions to detect actual condition of the available spectrum, whereby if the sensed spectrum sub-band condition is suitable for fronthaul application, then the F-RRH informs the UTM unit to use the spectrum for a specific period and in case the sensed spectrums are unsuitable, the F-RRH enters a relocation phase, wherein the UTM unit reused the LSP model to identify new 3D position within the TDA and after determining the new 3D position, the F-RRH relocated to the new position by the UTM unit to perform the spectrum sensing task to identify the current utilization of the predicted spectrum.

6. The method as claimed in claim 5, wherein the TDA includes a disaster area with destroyed or damaged S-RRHs with overlapping cellular communication regions by the existing working S-RRH adjacent to the TDA, whereby defining the TDA includes identifying the overlapped cellular boundaries or arc length (302) where the F-RRH simultaneously gets a significant number of UE coverage and signal strength for the fronthaul applications by calculating length of each arc with the TDA region the UTM unit (307);
wherein the calculating the arc length by the BBU unit involves considering a circular target area which overlaps with several adjacent circular cellular cells, where each adjacent cell has a base station at its center point with a coverage radius of ‘R’ and area of overlap between TDA and any of the adjacent cells is called the overlap area and the boundary of this overlap area is identified as the arc length.

7. The method as claimed in claim 5, wherein the determination of the possible F-RRH deployment 3D positions inside the TDA includes
identifying discrete possible locations over the arc length, to reduce F-RRH deployment time and calculating the number of 3D arc positions and inter-distance between them based on the arc length and the altitude of the F-RRH (308), wherein calculating the number of 3D arc positions involves determination of two endpoints of the arc length and other points over this arc by taking into consideration of coverage diameter of the F-RRH at a particular height, where each point over this arc is separated from each other by a length of coverage radius of the F-RRH and after determination of the all 2D points over the arc, 3D positions over this arc are obtained by varying the height (Z coordinate) over the identified 2D arc position, whereby minimum and maximum height of 3D positions are determined by considering the F-RRH transmission range and nature of the terrain;
initiating LSP model based on information regarding occupancy detail and attenuation profile for each available sub-band at the adjacent cells of the working S-RRH over the 3D arc positions as collected by the reconnaissance UAV to identify an optimum 3D position across each overlap arc length of the adjacent cells (310), whereby after obtaining the optimal 3D position, the UTM unit selects the required number of the F-RRH UAVs and instructs them to station at the determined 3-D positions laying over the overlap arc length (311).

8. The method as claimed in claim 5, includes post F-RRH deployment process involving the spectrum detector to know the post F-RRH deployment occupancy of the predicted spectrum sub-band comprising scanning the predicted sub-bands and their signal strength at the F-RRH deployed location (401) based on a transmitter detection mechanism using a knowledge-based energy detection (KED) method which works based on received signal strength measured in terms of Signal to Noise Ratio (SNR) at the transceiver module of the F-RRH (402);
wherein, if the received SNR is larger than a threshold SNR then the F-RRH transmits control information to the UTM unit regarding temporary occupancy of the selected spectrum for the establishment of the fronthaul link (403) and ff the UTM unit permits the F-RRH to use the identified sub-band, then it occupies the selected band for a time period (Tₒ) (404) which is decided based on average temporal traffic variation over the selected sub-band;
wherein the KED method (500) involves the spectrum detector (501) to identify the free spectrum sub-band based on the received SNR (402) and a noise estimator (502) to estimates presence of noise in the received signal and helps in hypothesis testing in order to identify the condition of the predicted spectrum sub-band, whereby the transceiver module of the F-RRH at a 3D arc position senses the targeted sub-band for a sensing period ‘Tₛ’ and estimates the spectrum sub-band conditions by the use of hypothesis testing as
$$\{ \begin{matrix}{H}_{0} : y ( t ) = w ( t ) , \\ {H}_{1} : y ( t ) = hx ( t ) + w ( t )\end{matrix} \qquad \begin{matrix}( 1 ) \\ ( 2 )\end{matrix}$$
where, y(t) is the output signal analysis over sensing time period ‘Tₛ’ and w(t) is the noise over a fading channel and x(t) is the input sample signal.

9. The method as claimed in claim 8, wherein the KED method involves a threshold estimator (503) to considers prior knowledge and estimates the threshold value for sensed spectrum sub-band, whereby the KED method utilizes the information obtained from the LSP method (305) as the prior knowledge about the spectrum sub-band and geographical location which helps to reduce the spectrum selection and searching time during the post-deployment phase.

10. The method as claimed in claim 5, includes relocation of the deployed F-RRH to a new 3-D position over the arc length depending on availability of currently used sub-band by the corresponding F-RRH, wherein the relocation to the new 3-D arc position is based on the knowledge of sub-band SNR values obtained in (310) and through the LSP method by interacting with environment and learning through actions' consequences, whereby the LSP method uses states and actions to predict the next location, here, the states include the probable 3-D positions and actions are the directions of F-RRH and in each state, the F-RRH observes and accumulates the SNR conditions, gathers location information, and takes corresponding actions for its next movement.
